(19) United States
(12) Patent Application Publication
(10) Pub. No.: US 2013/0034436 A1
(43) Pub. Date: Feb. 7, 2013

(54) Systems, Method, and Apparatus for Modifying a Turbine Casing

(71) Applicants: Sharadanandan Das, Bangalore (IN); Balachandran Kumaravelu, Bangalore (IN)

(72) Inventors: Sharadanandan Das, Bangalore (IN); Balachandran Kumaravelu, Bangalore (IN)

(73) Assignee: GENERAL ELECTRIC COMPANY, Schenectady, NY (US)

(21) Appl. No.: 13/196,062

(22) Filed: Aug. 2, 2011

(51) Int. Cl. F01D 25/28; B23P 6/00

(52) U.S. Cl. 415/213.1; 29/888.021

(57) ABSTRACT

Certain embodiments of the invention may include systems, methods, and apparatus for modifying a turbine casing. According to an example embodiment of the invention, a method is provided for modifying a turbine casing. The method can include providing one or more casing retention pin bores in the turbine casing; inserting a retention pin in the one or more casing retention pin bores; providing one or more patch ring segments configured to be radially constrained by at least a portion of the turbine casing and further configured to slide circumferentially in cooperation with at least a portion of the turbine casing, wherein the one or more patch ring segments comprise at least one retention pin locking bore; installing the one or more patch ring segments in the turbine casing to radially constrain the one or more patch ring segments; and engaging the retention pin in the at least one retention pin locking bore to circumferentially constrain the one or more patch ring segments to the turbine casing.

### FIELD OF THE INVENTION

This invention generally relates to turbines and in particular to modifying a turbine casing.

### BACKGROUND OF THE INVENTION

Blades or “buckets” are utilized in turbines for conversion of energy. The buckets are typically attached by one end to a rotor, while the opposite ends extend nearly to a circumferential casing associated with the turbine. A gap between the bucket ends and the casing is usually made as small as possible to minimize flow around the blade ends. During the operation of the turbine, certain conditions can arise that may cause the blade ends to scrape against the casing and damage the casing surface, and as a result, repairs are sometimes required. It is a common practice to repair a damaged turbine casing using patch ring segments or shims. Such materials can be attached to the inner diameter of the casing to repair the damaged casing surface. The patch ring segments can be secured with screws, but there is always a risk that a displaced screw may fall into the flow path and damage other components.

### BRIEF SUMMARY OF THE INVENTION

Some or all of the above needs may be addressed by certain embodiments of the invention. Certain embodiments of the invention may include systems, methods, and apparatus for modifying a turbine casing

According to an example embodiment of the invention, a method is provided for modifying a turbine casing. The method can include providing one or more casing retention pin bores in the turbine casing; inserting a retention pin in the one or more casing retention pin bores; providing one or more patch ring segments configured to be radially constrained by at least a portion of the turbine casing and further configured to slide circumferentially in cooperation with at least a portion of the turbine casing, wherein the one or more patch ring segments comprise at least one retention pin locking bore; installing the one or more patch ring segments in the turbine casing to radially constrain the one or more patch ring segments; and engaging the retention pin in the at least one retention pin locking bore to circumferentially constrain the one or more patch ring segments to the turbine casing.

According to another example embodiment of the invention, a system is provided. The system can include a gas turbine which may include a flow path stage casing. The system can include an assembly for repairing the casing. The assembly can include one or more casing retention pin bores in the casing; a retention pin in the one or more casing retention pin bores; one or more patch ring segments configured to be radially constrained by at least a portion of the casing and further configured to slide circumferentially during assembly or disassembly in cooperation with at least a portion of the turbine casing, wherein the one or more patch ring segments include at least one retention pin locking bore, and wherein the retention pin engages with the at least one retention pin locking bore to circumferentially constrain the one or more patch ring segments to the casing.

According to another example embodiment of the invention, an apparatus is provided. The apparatus can include an assembly for repairing a casing associated with a gas turbine flow path stage. The assembly can include one or more casing retention pin bores in the casing; a retention pin in the one or more casing retention pin bores; and one or more patch ring segments configured to be radially constrained by at least a portion of the casing and further configured to slide circumferentially during assembly or disassembly in cooperation with at least a portion of the turbine casing, wherein the one or more patch ring segments comprise at least one retention pin locking bore, and wherein the retention pin engages with the at least one retention pin locking bore to circumferentially constrain the one or more patch ring segments to the casing.

Other embodiments, features, and aspects of the invention are described in detail herein and are considered a part of the claimed inventions. Other embodiments, features, and aspects can be understood with reference to the following detailed description, accompanying drawings, and claims.

### BRIEF DESCRIPTION OF THE FIGURES

Reference will now be made to the accompanying drawings, which are not necessarily drawn to scale, and wherein:

FIG. 1 is a diagram of an illustrative turbine according to an example embodiment of the invention.

FIG. 2 is a diagram of a illustrative flow path stages of a turbine according to an example embodiment of the invention.

FIG. 3 is a perspective view diagram of an illustrative patch ring according to an example embodiment of the invention.

FIG. 4 is a diagram of an illustrative patch ring assembly according to an example embodiment of the invention.

FIG. 5 is a diagram of an illustrative patch ring assembly with an engaged retention pin according to an example embodiment of the invention.

FIG. 6 is a diagram of an illustrative patch ring assembly with pin retraction tool according to an example embodiment of the invention.

FIG. 7 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain example embodiments of the invention may enable attaching and securing the patch ring segments to the turbine casing. According to certain example embodiments, gas turbines casings may be repaired with patch rings when the flow path on the casing is damaged due to rubs or failure of rotor blades. According to example embodiments, grooves or slots may be made on the damaged flow path, and patch rings may slide into the grooves or slots to build the casing back to the desired casing dimension.

From a practical standpoint, it can be very difficult to slide a patch ring into casing grooves or slots when the patch ring is comprised of only a few segments. Therefore, according to an example embodiment of the invention, the patch rings can be made in 6-12 segments for ease of assembly. After assembly, the patch ring segments may not necessarily be an integral part of the casing, and gaps between each patch ring segment may be designed to account for the thermal growth during the gas turbine operation and/or to minimize stresses developed due to the thermal growth in each segment. According to an example embodiment, the patch ring segments may be individually secured to the casing by embodiments of the invention. This may be important for at least two reasons: (1) without securing the patch ring segments to avoid circumferential movement, segment gaps may accumulate to create creating a larger gap, and may create an aerodynamic concern, and (2) if instrumentation wires or probes pass through the patch ring, and if the patch ring moves, then the probes may bend or may shear due to the relative movement of patch ring with the casing.

Various assemblies and parts for attaching and securing the patch ring segments to the turbine casing will now be described with reference to the accompanying figures according to example embodiments of the invention. According to an example embodiment, spring-loaded pins may reside in bore holes in the casing, and may engage in locking bores in the patch ring sections to constrain the patch rings while averting the risk of falling into the flow path.

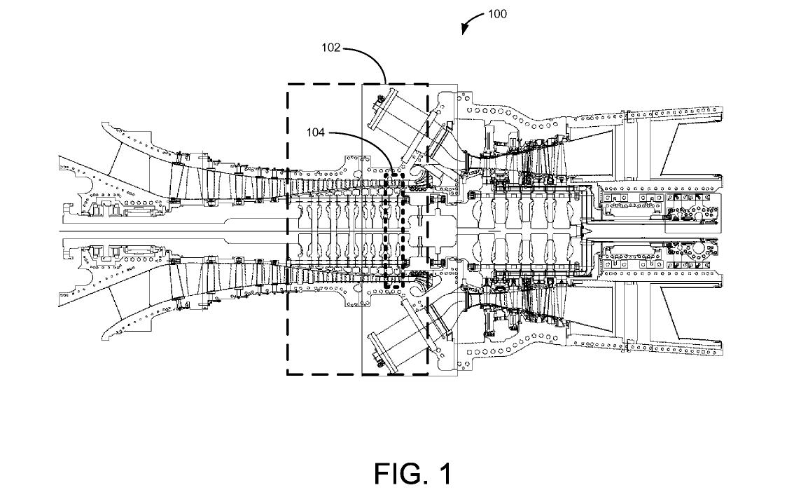

FIG. 1 depicts a turbine 100 with a flow path 102. The flow path may include buckets or blades that are attached to a rotor. The flow path 102 may be surrounded by a casing. The flow path 102 may include one or more stages 104 for which embodiments of the invention may be applied.

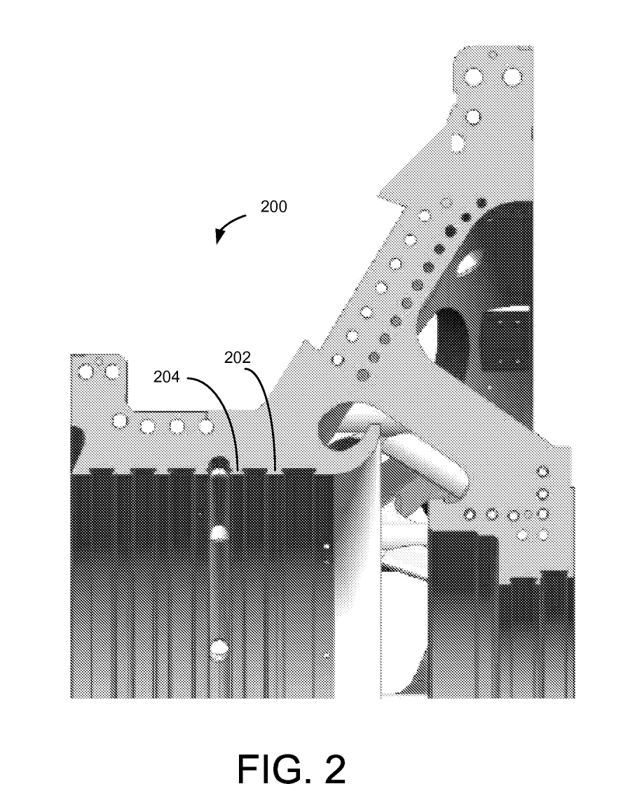

FIG. 2 depicts a close-up view of the turbine casing 200 showing flow path stages. The turbine casing may include multiple flow path stage interfaces. For example, stage n flow path interface 204 and/or a stage n+1 flow path interface 202 may be damaged and may need to be repaired.

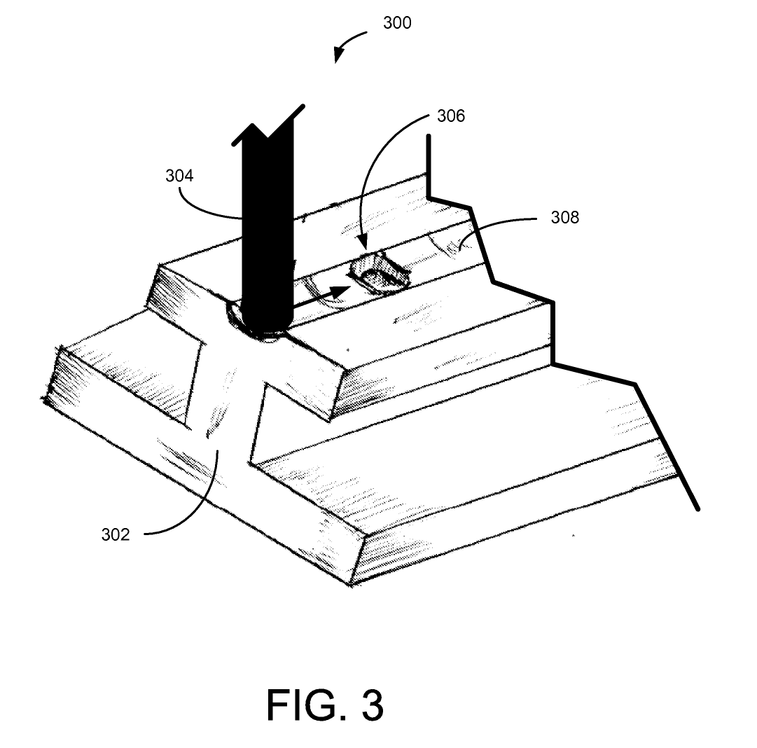

FIG. 3 depicts a perspective view of an illustrative patch ring assembly 300 according to an example embodiment of the invention. In an example embodiment, the patch ring assembly 300 may include a patch ring section 302, a retention pin 304, a retention pin locking bore 306, and an optional guide slot 308.

According to an example embodiment, the turbine casing may be modified to accept sections of a patch ring 302. In an example embodiment, a “T” shaped channel may be machined circumferentially into the turbine casing. A corresponding “T” shaped machined or attached protrusion on the patch ring section may slide into the casing channel to provide radial constraint of the patch ring sections against the casing, while allowing the patch ring sections to slide into place. According to an example embodiment, the patch ring sections may be constrained in the circumferential or axial direction with the retention pin 304. According to an example embodiment, the retention pin 304 may have a chamfer and the patch ring 302 may have a guide slot 308 or groove on top of it so that the pin 304 may be guided into the retention pin locking bore 306.

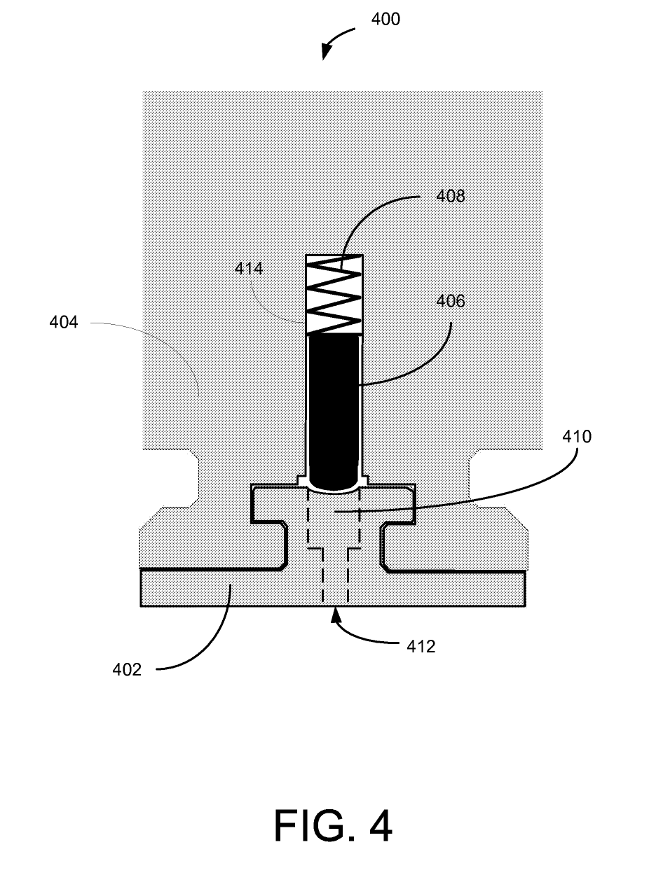

FIG. 4 depicts another view of the assembly 400 in an unlocked position, according to an example embodiment of the invention. The assembly 400 can include a patch ring segment 402, a portion of the turbine casing 404, a retention pin 406 (shown retracted into the casing retention pin bore 414), a compression spring 408, and a retention pin locking bore 410. In an example embodiment, the retention pin 406 may reside in the bore 414 within the casing 404, and may be loaded with the spring 408 so that the retention pin 406 can engage in the retention pin locking bore 410 within the patch ring segment 402 when the casing retention pin bore 414 aligns with the retention pin locking bore 410.

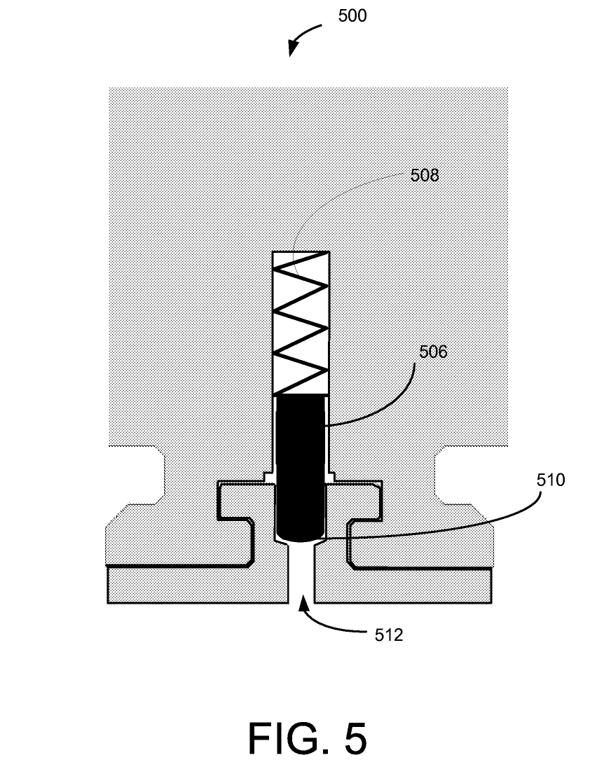

FIG. 5 depicts another view of the assembly 500 in a locked position. In accordance with an example embodiment of the invention, the patch ring segment (as in 402 of FIG. 4) may be positioned so that the retention pin 506 can engage with the retention pin locking bore 510. According to an example embodiment, the spring 508 may provide pressure to hold the retention pin 506 into the locking bore 510. In an example embodiment, when the retention pin 506 is engaged in the locking bore 510, the patch ring segment may be constrained from rotating circumferentially.

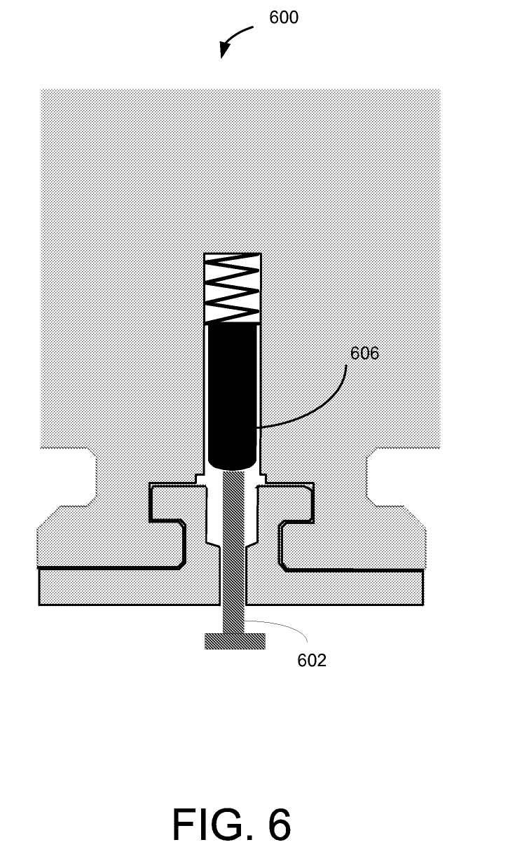

FIG. 6 depicts another view of the assembly 600, showing a retracted retention pin 606, according to an example embodiment of the invention. For example, a retraction tool 602 may be utilized to push the retention pin 606 back into the casing bore so that it can clear the patch ring segment and the patch ring segment may repositioned or removed. In an example embodiment, the retention pin retraction bore (as in 512 of FIG. 5) may have a smaller bore diameter than the retention pin 606 outer diameter.

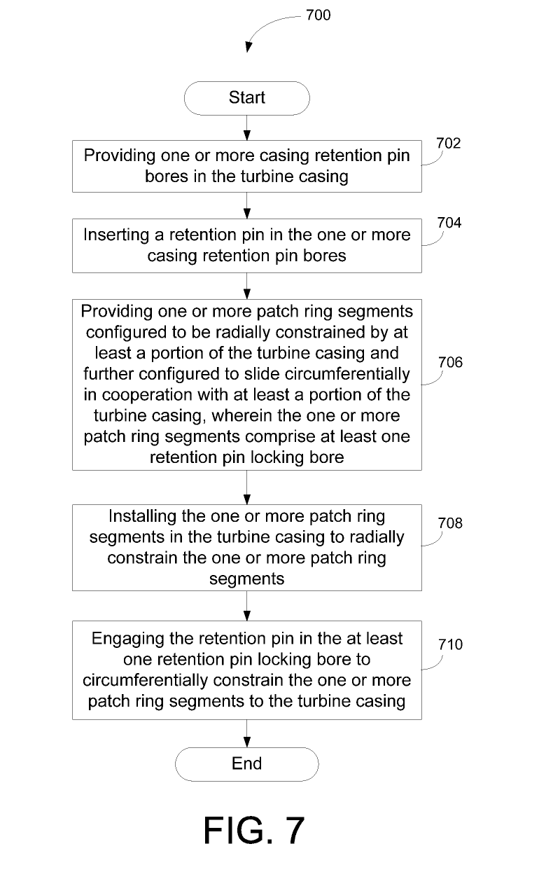

An example method 700 for modifying a turbine casing will now be described with reference to the flowchart of FIG. 7. The method 700 starts in block 702 and includes providing one or more casing retention pin bores in the turbine casing. In block 704, method 700 includes inserting a retention pin in the one or more casing retention pin bores. In block 706, method 700 includes providing one or more patch ring segments configured to be radially constrained by at least a portion of the turbine casing and further configured to slide circumferentially in cooperation with at least a portion of the turbine casing, wherein the one or more patch ring segments comprise at least one retention pin locking bore. In block 708, method 700 includes installing the one or more patch ring segments in the turbine casing to radially constrain the one or more patch ring segments. In block 710, method 700 includes engaging the retention pin in the at least one retention pin locking bore to circumferentially constrain the one or more patch ring segments to the turbine casing. Method 700 ends after block 710.

In example embodiments, engaging the retention pin (304) in the at least one retention pin locking bore (510) includes engaging at least a portion of the retention pin (304) in at least one of the one or more casing retention pin bores (414), and further engaging at least a portion of the retention pin (304) in the at least one retention pin locking bore (510) when the one or more casing retention pin bores (414) are circumferentially aligned with the at least one retention pin locking bore (510).

Example embodiments include inserting a spring (408) in the one or more casing retention pin bores (414), wherein the spring (408) provides force for engaging the retention pin (304) in the at least one retention pin locking bore (410). According to example embodiments, providing one or more casing retention pin bores (414) in the turbine casing (404) includes providing one or more radial bores in the turbine casing (404). In example embodiments, installing the one or more patch ring segments (402) in the turbine casing (404) includes installing the one or more patch ring segments (402) in a flow path stage (204) associated with the turbine. In example embodiments, providing one or more patch ring segments (402) further includes providing a guide slot (308) in the one or more patch ring segments (402) for guiding the retention pin (304) into the at least one retention pin locking bore (410). According to example embodiments, providing one or more patch ring segments (402) further includes providing a retention pin retraction bore (512) for disengaging the retention pin (304) from the least one retention pin locking bore (410), wherein the retention pin retraction bore (512) includes a diameter smaller than the diameter of the retention pin (304).

Example embodiments of the invention include system and an apparatus. The system can include a gas turbine (100) that includes a flow path stage casing (404). The system and the apparatus can include an assembly for repairing the casing (404). The assembly can include one or more casing retention pin bores (414) in the casing (404); a retention pin (304) in the one or more casing retention pin bores (414); one or more patch ring segments (402) configured to be radially constrained by at least a portion of the casing (404) and further configured to slide circumferentially during assembly or disassembly in cooperation with at least a portion of the turbine casing (404), wherein the one or more patch ring segments include at least one retention pin locking bore (510), and wherein the retention pin (304) engages with the at least one retention pin locking bore (510) to circumferentially constrain the one or more patch ring segments (402) to the casing (404).

According to example embodiments, the retention pin is operable to engage with at least a portion of one of the one or more casing retention pin bores (414), and wherein the retention pin is further operable to engage with at least a portion of the at least one retention pin locking bore (510) when the one or more casing retention pin bores (414) are circumferentially aligned with the at least one retention pin locking bore (510).

According to example embodiments, the system and/or the apparatus can include a spring (408) positioned in the one or more casing retention pin bores (414), wherein the spring (408) provides force for engaging the retention pin (304) in the at least one retention pin locking bore (410). In an example embodiment, the one or more casing retention pin bores (414) include radial bores in the casing (404). In an example embodiment, the one or more patch ring segments (402) further include a guide slot (308) for guiding the retention pin (304) into the at least one retention pin locking bore (410). In example embodiments, the one or more patch ring segments (402) further include a retention pin retraction bore (512) for disengaging the retention pin (304) from the least one retention pin locking bore (410), wherein the retention pin retraction bore (512) includes a diameter smaller than the diameter of the retention pin (304).

According to example embodiments, certain technical effects can be provided, such as creating certain systems, methods, and apparatus that provide securing patch ring segments to a turbine casing while avoiding the use of screws or other fastening devices that could fall in the flow path.

In example embodiments of the invention, the assembly 300, 400, 500, and 600 may include any number of hardware components to facilitate any of the operations described by the methods described herein, such as 700 in FIG. 7.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for modifying a turbine casing, the method comprising:
providing one or more casing retention pin bores in the turbine casing;
inserting a retention pin in the one or more casing retention pin bores;
providing one or more patch ring segments configured to be radially constrained by at least a portion of the turbine casing and further configured to slide circumferentially in cooperation with at least a portion of the turbine casing, wherein the one or more patch ring segments comprise at least one retention pin locking bore;
installing the one or more patch ring segments in the turbine casing to radially constrain the one or more patch ring segments; and
engaging the retention pin in the at least one retention pin locking bore to circumferentially constrain the one or more patch ring segments to the turbine casing.

2. The method of claim 1, wherein engaging the retention pin in the at least one retention pin locking bore comprises engaging at least a portion of the retention pin in at least one of the one or more casing retention pin bores, and further engaging at least a portion of the retention pin in the at least one retention pin locking bore when the one or more casing retention pin bores are circumferentially aligned with the at least one retention pin locking bore.

3. The method of claim 1, further comprising inserting a spring in the one or more casing retention pin bores, wherein the spring provides force for engaging the retention pin in the at least one retention pin locking bore.

4. The method of claim 1, wherein providing one or more casing retention pin bores in the turbine casing comprises providing one or more radial bores in the turbine casing.

5. The method of claim 1, wherein installing the one or more patch ring segments in the turbine casing comprises installing the one or more patch ring segments in a flow path stage associated with the turbine.

6. The method of claim 1, wherein providing one or more patch ring segments further comprises providing a guide slot in the one or more patch ring segments for guiding the retention pin into the at least one retention pin locking bore.

7. The method of claim 1, wherein providing one or more patch ring segments further comprises providing a retention pin refraction bore for disengaging the retention pin from the least one retention pin locking bore, wherein the retention pin retraction bore comprises a diameter smaller than the diameter of the retention pin.

8. A system comprising:
a gas turbine comprising a flow path stage casing;
an assembly for repairing the casing, the assembly comprising:
one or more casing retention pin bores in the casing;
a retention pin in the one or more casing retention pin bores;
one or more patch ring segments configured to be radially constrained by at least a portion of the casing and further configured to slide circumferentially during assembly or disassembly in cooperation with at least a portion of the turbine casing, wherein the one or more patch ring segments comprise at least one retention pin locking bore, and wherein the retention pin engages with the at least one retention pin locking bore to circumferentially constrain the one or more patch ring segments to the casing.

9. The system of claim 8, wherein the retention pin is operable to engage with at least a portion of one of the one or more casing retention pin bores, and wherein the retention pin is further operable to engage with at least a portion of the at least one retention pin locking bore when the one or more casing retention pin bores are circumferentially aligned with the at least one retention pin locking bore.

10. The system of claim 8, further comprising a spring positioned in the one or more casing retention pin bores, wherein the spring provides force for engaging the retention pin in the at least one retention pin locking bore.

11. The system of claim 8, wherein the one or more casing retention pin bores comprises radial bores in the casing.

12. The system of claim 8, wherein the one or more patch ring segments further comprises a guide slot for guiding the retention pin into the at least one retention pin locking bore.

13. The system of claim 8, the one or more patch ring segments further comprise a retention pin retraction bore for disengaging the retention pin from the least one retention pin locking bore, wherein the retention pin retraction bore comprises a diameter smaller than the diameter of the retention pin.

14. An apparatus comprising:
an assembly for repairing a casing associated with a gas turbine flow path stage, the assembly comprising:
one or more casing retention pin bores in the casing;
a retention pin in the one or more casing retention pin bores; and
one or more patch ring segments configured to be radially constrained by at least a portion of the casing and further configured to slide circumferentially during assembly or disassembly in cooperation with at least a portion of the turbine casing, wherein the one or more patch ring segments comprise at least one retention pin locking bore, and wherein the retention pin engages with the at least one retention pin locking bore to circumferentially constrain the one or more patch ring segments to the casing.

15. The assembly of claim 14, wherein the retention pin is operable to engage with at least a portion of one of the one or more casing retention pin bores, and wherein the retention pin is further operable to engage with at least a portion of the at least one retention pin locking bore when the one or more casing retention pin bores are circumferentially aligned with the at least one retention pin locking bore.

16. The assembly of claim 14, further comprising a spring positioned in the one or more casing retention pin bores, wherein the spring provides force for engaging the retention pin in the at least one retention pin locking bore.

17. The assembly of claim 14, wherein the one or more casing retention pin bores comprises radial bores in the casing.

18. The assembly of claim 14, wherein the one or more patch ring segments further comprises a guide slot for guiding the retention pin into the at least one retention pin locking bore.

19. The assembly of claim 14, the one or more patch ring segments further comprise a retention pin refraction bore for disengaging the retention pin from the least one retention pin locking bore, wherein the retention pin retraction bore comprises a diameter smaller than the diameter of the retention pin.

20. The assembly of claim 14, further comprising a retraction tool having an outer diameter smaller than an inner diameter of the retention pin retraction bore and operable to retract the retention pin for disassembly.
